(19) United States
(12) Patent Application Publication
(10) Pub. No.: US 2015/0008301 A1
(43) Pub. Date: Jan. 8, 2015

(54) CLAMPING FIXTURE

(71) Applicants: Fu Tai Hua Industry (Shenzhen) Co., Ltd., Shenzhen (CN); Hon Hai Precision Industry Co., Ltd., New Taipei (TW)

(72) Inventor: JU-LAN HAO, Shenzhen (CN)

(21) Appl. No.: 14/322,023

(22) Filed: Jul. 2, 2014

(30) Foreign Application Priority Data
Jul. 4, 2013 (CN) 2013102784184

(51) Int. Cl. B23Q 3/18; F16B 2/12

(52) U.S. Cl. CPC B23Q 3/18; F16B 2/12
USPC 248/346.03

(57) ABSTRACT

A clamping fixture includes a tray, a handle received into the tray, a first clamping element, a second clamping element, a transmission mechanism, and a connection handle. The first clamping element is slidably received into the first sliding groove and is connected to the handle. The tray defines a receiving chamber for placing a workpiece. The receiving chamber includes a first side end and a second side end substantially perpendicular to the first side end. The first side end defines a first sliding groove, and the second side end defines a second sliding groove. One end of the connection handle is fixedly connected to the first clamping element, and another end of the connection handle is connected to the second clamping element through the transmission mechanism.

### CROSS-REFERENCE TO RELTATED APPLICATIONS

This application claims priority to Chinese Patent Application No. 201310278418.4 filed on Jul. 4, 2013 in the China Intellectual Property Office, the contents of which are incorporated by reference herein.

### FIELD

The present disclosure relates to fixtures, and particularly to a clamping fixture.

### BACKGROUND

When processing products, a clamping fixture is needed to clamp the products.

### BRIEF DESCRIPTION OF THE DRAWINGS

FIG. 1 is an isometric view of an embodiment of the clamping fixture on with a workpiece.

FIG. 2 is an exploded view of the clamping fixture of FIG. 1.

FIG. 3 is an exploded view of the clamping fixture of FIG. 1, viewed from another angle.

FIG. 4 is a portion of a cross-sectional perspective view of the clamping fixture of FIG. 1 fixing the workpiece.

FIG. 5 is an enlarged view taken along line V of FIG. 4.

FIG. 6 is a portion of a cross-sectional perspective view of the clamping fixture of FIG. 1 of separating from the workpiece.

FIG. 7 is an enlarged view taken along line VII of FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Embodiments of the present disclosure will be described with reference to the accompanying drawings.

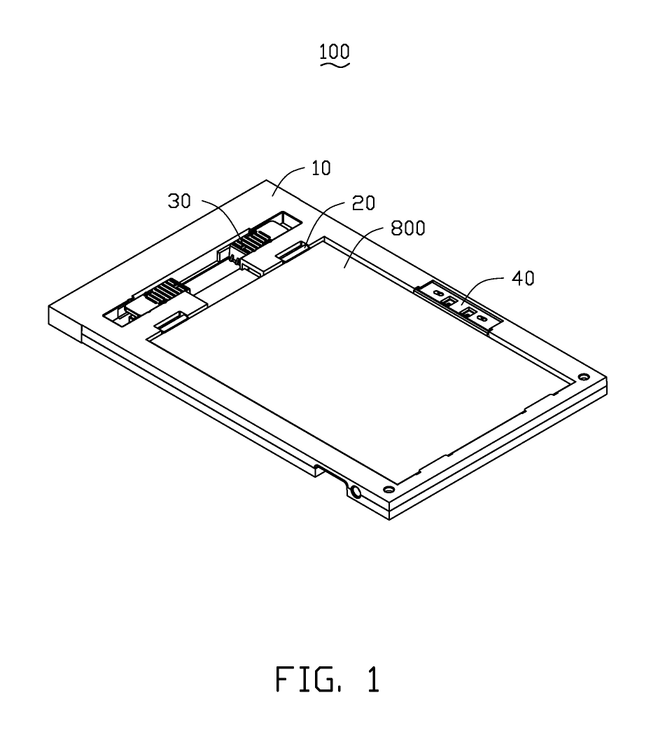

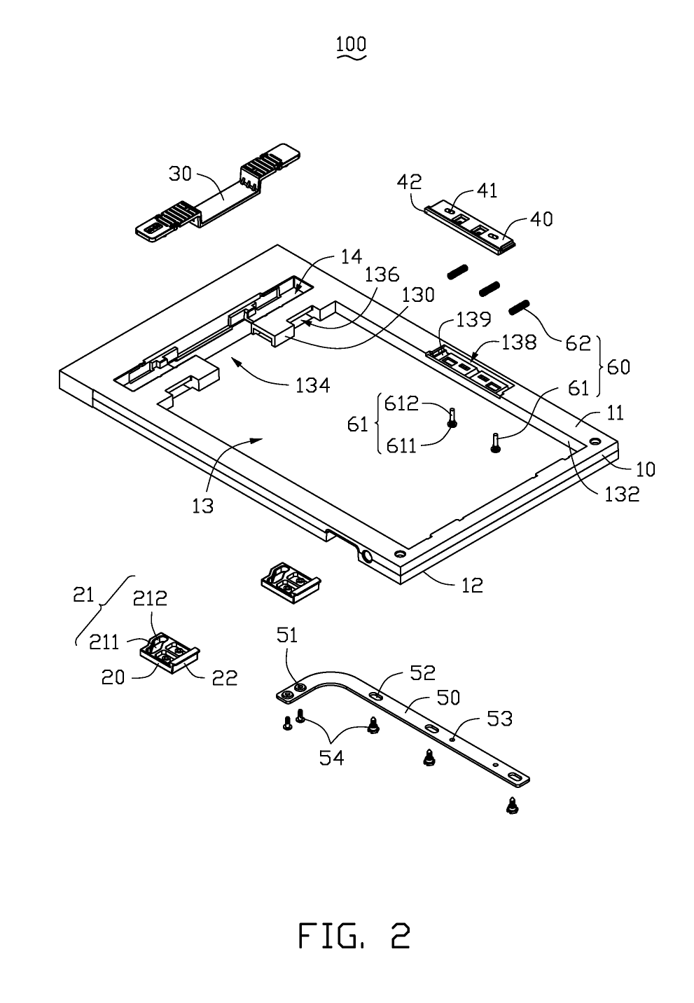

FIG. 1 illustrates a clamping fixture 100 for clamping a workpiece 800 (as shown in FIG. 2). The clamping fixture 100 includes a tray 10, two first clamping elements 20, a handle 30, and a second clamping element 40.

FIG. 2 illustrates that the clamping fixture 100 further includes a connection handle 50, and a transmission mechanism 60. The tray 10 includes a first surface 11 and a second surface 12 opposite to the first surface 11. In one embodiment, the tray 10 is rectangular. The first surface 11 defines a receiving chamber 13, and a receiving groove 14. The receiving chamber 13 is used for receiving the workpiece 800. The receiving groove 14 is used for accommodating the handle 30. The receiving chamber 13 includes a first side end 130 and a second side end 132 substantially perpendicular to the first side end 130. The first side end 30 defines a gap 134 and two first sliding grooves 136 arranged on two opposite sides of the gap 134. The second side end 132 defines a second sliding groove 138. The gap 134 is used for providing a space for a user to take the workpiece 800 out of the receiving chamber 13 when the workpiece 800 is separated from the first clamping elements 20 and the second clamping element 40. The second sliding groove 138 defines a number of first grooves 139 at a bottom. In one embodiment, the section of the first groove 139 is semicircular.

Each of the two first clamping elements 20 is slidably received into one of the two first sliding grooves 136, and defines a first guiding groove 21. The first clamping element 20 includes a first clamping surface 22 opposite to the first guiding groove 21. The first clamping surface 22 can be slid out of the first sliding groove 136 to clamp the workpiece 800. The first guiding groove 21 includes a first linear groove 211 and two second linear grooves 212 arranged at two opposite ends of the first linear groove 211. An extending direction of the first linear groove 211 is inclined with a sliding direction of the first clamping element 20 and a length direction of the receiving groove 14. An extending direction of the second linear groove 212 is substantially perpendicular to the sliding direction of the first clamping element 20.

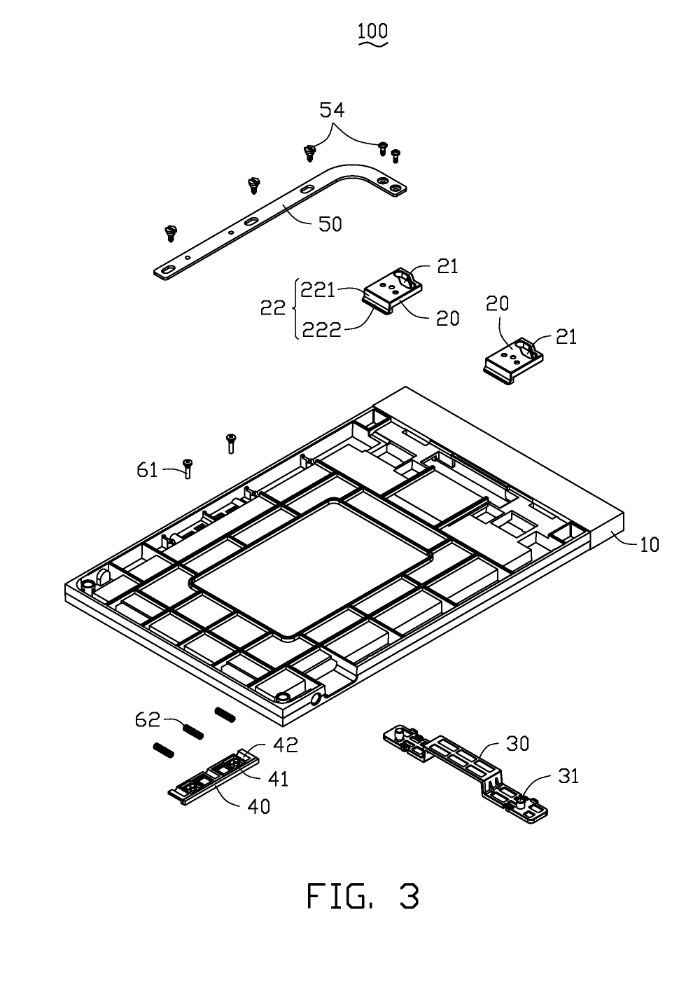

Referring to FIG. 3, the first clamping surface 22 includes a first side surface 221 and a top surface 222 perpendicularly connected to one end of the first side surface 221. The first side surface 221 is for resisting one side of the workpiece 800, and the top surface 222 is for resisting the top surface of the workpiece 800, thereby limiting the movement of the workpiece 800 in the receiving chamber 13.

The handle 30 can be slidably received into the receiving groove 14 and is slidable along the length of the receiving groove 14. The handle 30 includes two guide rods 31 on a bottom. The two guide rods 31 are received into the two first guiding grooves 21, thereby connecting the two first clamping elements 20 to the handle 30. When an external force drives the handle 30 along the receiving groove 14, the two guide rods 31 are driven to move along the two first guiding grooves 21. In detail, because the extending direction of the first linear groove 211 is inclined with the sliding direction of the first clamping element 20 and the length of the receiving groove 14, when the two guide rods 31 are moved along the two first linear grooves 211, the two first clamping elements 20 are slid by the two guide rods 31 out of the first sliding grooves 36 or slid into the first sliding grooves 136. Because the extending direction of the second linear groove 212 is substantially perpendicular to the sliding direction of the first clamping element 20, when the two guide rods 31 are moved along the two second linear grooves 212, the first clamping elements 20 cannot slide relative to the first sliding groove 136.

The second clamping element 40 can be slidably received into the second sliding groove 138, and is slidable along a width direction of the second sliding groove 138. The second clamping element 40 defines a second guiding groove 41, and includes a second clamping surface 42. An extending direction of the second guiding groove 41 is inclined with a sliding direction of the second clamping element 40. The second clamping surface 42 is for resisting another side of the workpiece 800 when the second clamping element 40 is slid out of the second sliding groove 138. The second clamping element 40 defines a number of second grooves 43 aligned with the first grooves 139 at a bottom. In one embodiment, the section of the second groove 43 is semicircular.

Referring to FIG. 2 again, the connection handle 50 is an L-shape. One side of the connection handle 50 defines a number of through holes 51, and another side of the connection handle 50 defines a number of sliding grooves 52 and fixing holes 53. A length direction of the sliding groove 52 is parallel to the sliding direction of the first clamping element 20. The connection handle 50 further includes a number of fastening elements 54, such as screws. Some fastening elements 54 pass through the through holes 51, and are fixed to one of the two first clamping elements 20, and the remaining fastening elements 54 pass through the sliding grooves 52, and are fixed to the tray 10, thereby coupling the connection handle 50 to the first clamping element 20 and the tray 10.

The transmission mechanism 60 is used for connecting the second clamping element 40 to the connection handle 50. The transmission mechanism 60 includes a bolt 61 and a number of elastic elements 62. The bolt 61 includes a head portion 611 and a pole 612. The pole 612 passes through the fixing hole 53, and is received into the second guiding groove 41. In one embodiment, the diameter of the pole 612 is slightly less than the width of the second guiding groove 41, thereby the pole 612 touches one of the side ends of the second guiding groove 41. The elastic element 62 is received into a groove formed by the first groove 139 and the second groove 43, and resists the tray 10 and the second clamping element 40.

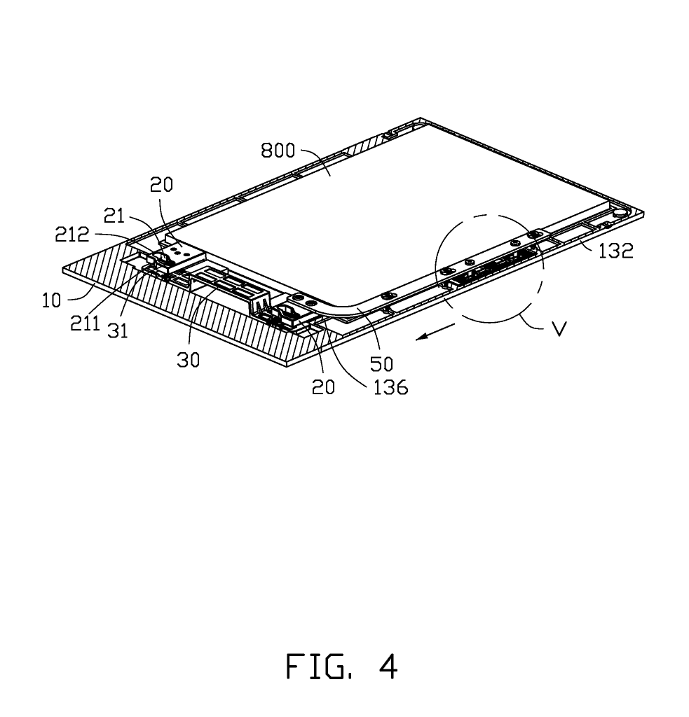

FIG. 4 illustrates when the handle 30 slides adjacent to the second side end 132, the two guide rods 31 are driven by the handle 30 to slide from one of the second linear groove 212 to the first linear groove 211. During a slide of the two guide rods 31 along the first linear groove 211 to another second linear groove 212, the two first clamping elements 21 are slid by the two guide rods 31 out of the two first sliding grooves 136 to resist one side of the workpiece 800. During a slide of the first clamping elements 21, the connection handle 50 is moved by the first clamping element 21 towards a direction adjacent to the sliding groove 136.

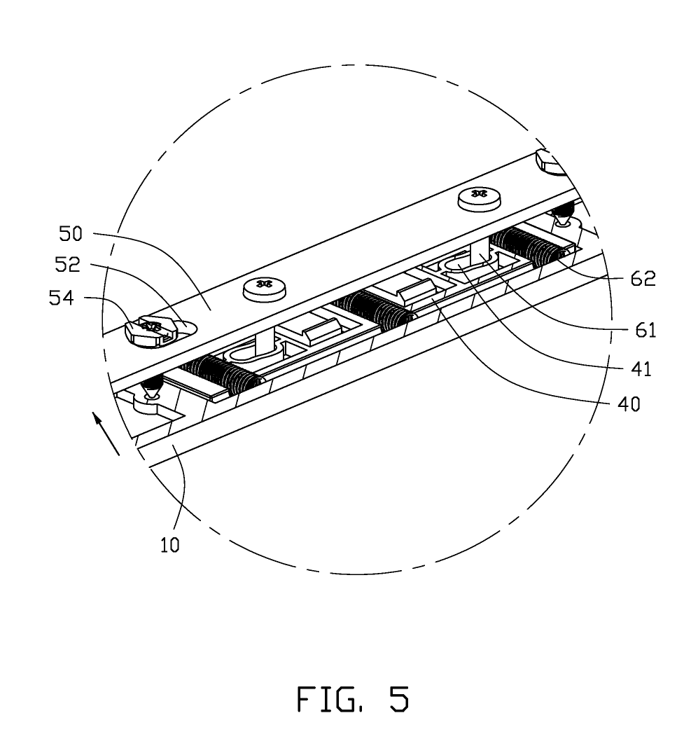

Referring to FIG. 5, during movement of the connection handle 50, the bolt 61 slides along the second guiding groove 41 to compress the elastic elements 62 with the tray 10. The elastic elements 62 rebound to drive the second clamping element 40 to resist the other side of the workpiece 800.

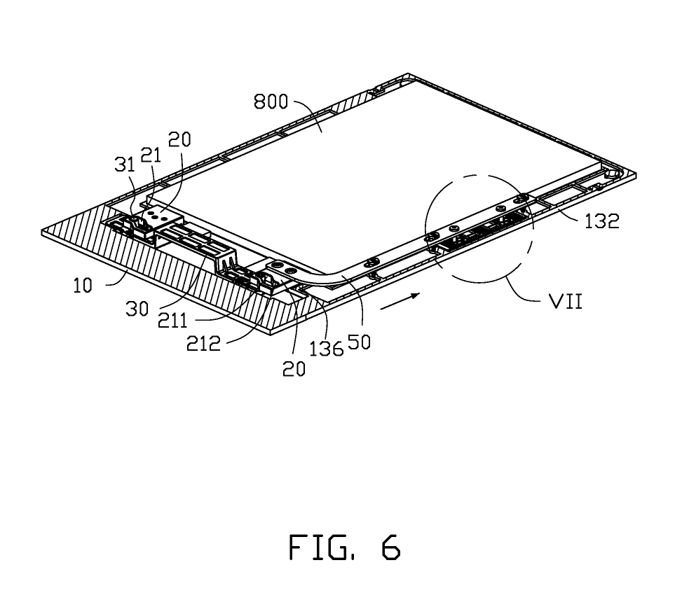

Referring to FIG. 6, when the handle 30 slides away from the second side end 132, the two guide rods 31 are driven by the handle 30 to slide from the second linear groove 212 to the first linear groove 211. During a sliding of the two guide rods 31 along the first linear groove 211 to the second linear groove 212, the two first clamping elements 21 are slid by the two guide rods 31 into the two first sliding grooves 136, thereby separating the first clamping surface from the side of the workpiece 800. During a sliding of the first clamping elements 21, the connection handle 50 is moved by the first clamping element 21 towards a direction away from the sliding groove 136.

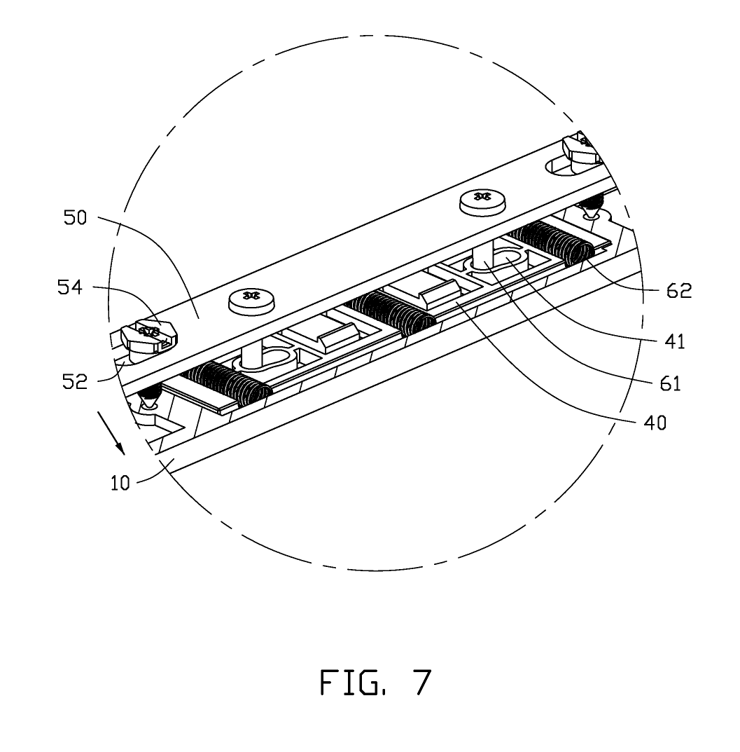

Referring to FIG. 7, during movement of the connection handle 50, the bolt 61 slides along the second guiding groove 41 to return to an original position. The elastic elements 62 return to an original position. Because the force from the elastic elements 62 is released, the second clamping element 40 cannot resist the other side of the workpiece 800. Then, the user can take the workpiece 800 out of the receiving chamber 13 via the gap 134.

In at least one embodiment, the transmission mechanism 60 does not include the elastic elements 62. The diameter of the pole 61 is equal to the width of the second guiding groove 41, thereby the two side ends of the second guiding groove 41 touch the pole 612. While moving the connection handle 50, the bolt 61 slides along the second guiding groove 41 to slide the second clamping element 40 out of the second sliding groove for resisting another side of the workpiece 800.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A tray defining a receiving chamber configured to receive a workpiece, the receiving chamber comprising a first side end and a second side end substantially perpendicular to the first side end, the first side end defining a first sliding groove, and the second side end defining a second sliding groove;
a handle receivable by the tray;
a first clamping element slidably receivable by the first sliding groove and connected to the handle;
a second clamping element slidably receivable by the second sliding groove;
a transmission mechanism; and
a connection handle, wherein one end of the connection handle is fixedly connected to the first clamping element, and another end of the connection handle is intermediately connected to the second clamping element via the transmission mechanism.

2. The clamping fixture as described in claim 1, wherein the tray further defines a receiving groove for accommodating the handle.

3. The clamping fixture as described in claim 1, wherein the first side end further defines a gap for providing a space for a user to take the workpiece out of the receiving chamber.

4. The clamping fixture as described in claim 2, wherein the handle comprises a guide rod on a bottom thereof, the first clamping element defines a first guiding groove, the guide rod is received into the first guiding groove to connect the first clamping element to the handle.

5. The clamping fixture as described in claim 4, wherein the first guiding groove comprises a first linear groove and two second linear grooves arranged on two opposite ends of the first linear groove, an extending direction of the first linear groove is inclined with a sliding direction of the first clamping element and a length direction of the receiving groove, and an extending direction of the two second linear grooves are substantially perpendicular to the sliding direction of the first clamping element.

6. The clamping fixture as described in claim 4, wherein the first clamping element comprises a first clamping surface opposite to the first guiding groove, the clamping surface comprises a first side surface for resisting one side of the workpiece and a top surface perpendicularly connecting to one end of the first side surface for resisting a top surface of the workpiece.

7. The clamping fixture as described in claim 5, wherein the second clamping element comprises a second clamping surface for resisting another side of the workpiece.

8. The clamping fixture as described in claim 7, wherein the second clamping element defines a second guiding groove thereon, and an extending direction of the second guiding groove is inclined with a sliding direction of the second clamping element.

9. The clamping fixture as described in claim 8, wherein the connection handle is an L shape, one side of the connection handle defines a plurality of through holes, and another side of the connection handle defines a plurality of sliding grooves and fixing holes, the connection handle comprises a plurality of fastening elements, many fastening elements pass through the through holes, and are fixed to the first clamping elements, and the reminding fastening elements pass through the sliding grooves, and are fixed to the tray, thereby connecting the connection handle to the first clamping element and the tray.

10. The clamping fixture as described in claim 9, wherein the transmission mechanism comprises a bolt and a plurality of elastic elements, the bolt comprises a head portion and a pole, the pole passes through the fixing hole, and is received into the second guiding groove, thereby connecting the second clamping element to the connection handle, the second sliding groove defines a plurality of first grooves at the bottom thereof, the second clamping element defines a plurality of second grooves aligned with the first grooves at the bottom thereof, the plurality of elastic elements are respectively received into grooves formed by the first grooves and the second grooves.

11. The clamping fixture as described in claim 10, wherein the sections of the plurality of first grooves and second grooves are semicircular.

12. The clamping fixture as described in claim 10, wherein the diameter of the pole is slightly less than the width of the second guiding groove.
